(19) United States
(12) Patent Application Publication
(10) Pub. No.: US 2026/0180236 A1
(43) Pub. Date: Jun. 25, 2026

(54) CONNECTOR INTERFACE

(71) Applicant: LYTEN SWEDEN AB, Stockholm (SE)

(72) Inventors: Gustaf SJÖSTRAND, Enskededalen (SE); Jaime GARCIA DIAZ ALEJO, Stockholm (SE); David LINDER, Saltsjöbaden (SE)

(21) Appl. No.: 19/126,140

(22) PCT Filed: Oct. 30, 2023
(86) PCT No.: PCT/EP2023/080270

§ 371 Date: Apr. 30, 2025

(30) Foreign Application Priority Data
Oct. 31, 2022 (SE) 2251267-7

(51) Int. Cl. H01R 13/516; H01M 10/0525; H01R 13/447; H01R 13/52; H01R 13/627; H01R 13/631; H01R 13/641

(52) U.S. Cl. CPC H01R 13/516; H01M 10/0525; H01R 13/447; H01R 13/5213; H01R 13/6272; H01R 13/631; H01R 13/641

(57) ABSTRACT

A connector interface of an energy storage system, the connector interface comprising at least one first connector port, a second connector port, and a cover movable between a first position and a second position, wherein when in the first position, the cover is configured to prevent at least one first connector being put in connection with and/or disconnected from the at least one first connector port, when in the second position, the cover is configured to enable at least one first connector to be put in connection with and/or disconnected from the at least one first connector port, and wherein the cover is configured to be retained in the first position by a second connector when the second connector is connected to the second connector port, wherein disconnection of the second connector from the second connector port removes power from the at least one first connector port.

### TECHNICAL FIELD

The present disclosure relates to the field of energy storage systems comprising one or more battery packs, and more particular to energy storage systems for electric applications and connector interfaces for such energy storage systems.

### BACKGROUND

Energy storage systems (ESS) may comprise one or more battery packs and a controller, also called a hub, interconnected by cabling. In many cases, connections between the individual packs and the hub can provide a number of issues. In particular, current system designs often allow a user to disconnect a DC connection while it is under load, which is a significant safety hazard. One solution to this is the implementation of a high-voltage interlock loop (HVIL), for example via a magnetic switch in the door of a unit. However, this creates a single point of failure. Running a HVIL through the DC connectors themselves is another solution, however it is both costly and unreliable.

Therefore, there is a need for improvements to ESSs that enable safe user interaction with the system.

### SUMMARY

It is in view of the above considerations and others that the embodiments of the present invention have been made. The present disclosure aims at enabling safe user interaction with an ESS by providing a physical limitation in the connector interface of a unit that prohibits the user from disconnecting a first connection before disconnecting a second connection that removes power from the first connection. This can involve disconnecting a low-voltage connection, or a connection having HVIL protection, before any high-voltage or unprotected connections are removed. This is achieved by the implementation of a cover that encloses or prevents access to a first connector, and that can only be opened when a second connector has been removed. This provides a simple mechanical solution with no electrical failure risk, therefore having high reliability, and in case of failure, no impact on the uptime of the ESS. The cover may provide an intuitive interface for a user, enabling them to comprehend easily how to open the cover and interact with the connector interface in a safe manner.

According to an aspect, the present disclosure provides a connector interface of an energy storage system, the connector interface comprising at least one first connector port, a second connector port, and a cover movable between a first position and a second position, wherein when in the first position, the cover is configured to prevent at least one first connector being put in connection with and/or disconnected from the at least one first connector port, when in the second position, the cover is configured to enable at least one first connector to be put in connection with and/or disconnected from the at least one first connector port, and wherein the cover is configured to be retained in the first position by a second connector when the second connector is connected to the second connector port, wherein disconnection of the second connector from the second connector port removes power from the at least one first connector port.

Optionally, a connection between the second connector and the second connector port is a low-voltage connection, and a connection between the at least one first connector and the at least one first connector port is a high-voltage connection. Optionally, a connection between the second connector and the second connector port is a first high-voltage connection with a safety mechanism such as a high-voltage interlock loop, and a connection between the at least one first connector and the at least one first connector port is a second high-voltage connection without a safety mechanism. Optionally, the connector interface comprises two first connector ports, a connection between the second connector and the second connector port is a low-voltage connection, and a connection between each first connector port and a respective connector is a high-voltage connection. Optionally, the high voltage connection is a DC connection.

Optionally, disconnection of the second connector from the second connector port enables movement of the cover between the first and second positions. Optionally, in the second position, the cover is configured to prevent connection of the second connector to the second connector port. Optionally, the circuit coupled to the at least one first connector is connected to a switch or relay, that is configured to remove power from the first connector when the second connector is removed. Optionally, the cover is configured to be retained in the first position by a mechanical abutment or a magnetic interaction with the second connector when the second connector is connected to the second connector port. Optionally, the cover is movable between the first position and the second position by means of a hinge mechanism or a sliding mechanism. Optionally, the cover is configured to be retained in the second position.

According to an aspect, the present disclosure provides a battery pack for an energy storage system, the battery pack comprising a connector interface. According to an aspect, the present disclosure provides an energy storage system comprising a plurality of battery packs.

According to an aspect, the present disclosure provides a cover for a connector interface of an energy storage system, the connector interface comprising at least one first connector port and a second connector port, wherein the cover is movable between a first position and a second position, such that when in the first position, the cover is configured to prevent removal of at least one first connector that is connected to the at least one first connector port, and when in the second position, the cover is configured to enable removal of the at least one first connector from the at least one first connector port; wherein the cover is configured to be retained in the first position by a second connector when the second connector is connected to the second connector port, wherein removal of the second connector from the second connector port breaks a circuit coupled to the at least one first connector port.

### BRIEF DESCRIPTION OF THE DRAWINGS

The embodiments disclosed herein are illustrated by way of example, and by not by way of limitation, in the figures of the accompanying drawings. Like reference numerals refer to corresponding parts throughout the drawings, in which:

FIG. 1 is a perspective view of an energy storage system according to an example,

FIG. 2 is a block diagram of an example embodiment of an energy storage system,

FIG. 3 illustrates example configurations for connecting units of an energy storage system,

FIG. 4 shows a connector interface for a unit of an energy storage system,

FIGS. 5a-b show circuit diagrams for example configurations of energy storage system,

FIGS. 6a-b show a connector interface including a cover according to a first example,

FIGS. 7a-b show a connector interface including a cover according to a second example, and

FIGS. 8a-b show a connector interface including a cover according to a third example.

### DETAILED DESCRIPTION

Embodiments of the present disclosure will now be described more fully hereinafter. The apparatus disclosed herein can, however, be realized in many different forms and should not be construed as being limited to the aspects set forth herein.

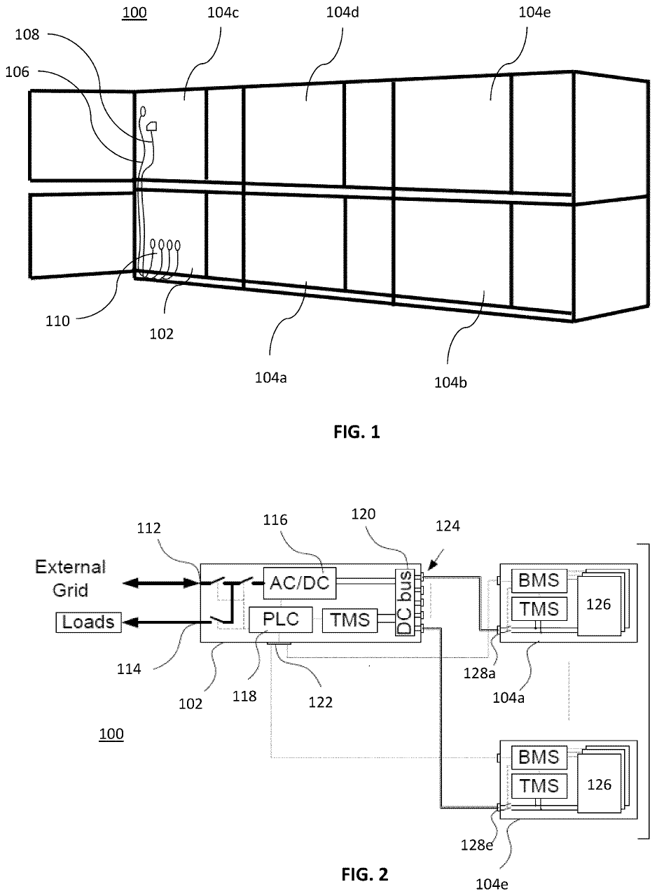

FIG. 1 is a perspective view of an energy storage system (ESS) 100 comprising a controller, also called a hub, 102 and a number of battery packs 104a-e, commonly denoted 104. The hub 102 is used for control of the ESS 100. In some embodiments, the hub 102 may be omitted and its functionality may be decentralised across the ESS. Each battery pack 104 may be provided as a separate unit. Each battery pack 104 may be interconnected with the hub 102 depending on the application requirements for the ESS 100. Whilst five battery packs 104 are shown in FIG. 1, it will be appreciated that any suitable number of battery packs 104 could be provided in the ESS 100, providing modular scalability of the ESS 100. The modular functionality of the ESS 100 enables the most appropriate configuration to be deployed at each site.

The hub 102 contains the necessary power and control equipment to facilitate the distribution and conversion of power from the battery units 104. As an example, the hub 102 may contain liquid-cooled power electronic modules for power conversion, integrated controllers for battery system and energy management, a transformer for galvanic isolation and necessary protection and monitoring systems. The hub 102 provides a 400V AC pluggable input and output, allowing the ESS 100 to interface to battery packs 104 and standard distribution equipment for providing standard distribution output from the battery packs 104 and for charging the battery packs 104. This “plug and play” functionality for adding or removing battery packs 104 to the ESS 100 leads to quicker and cheaper site deployments which results in simpler operations.

A battery pack 104 comprises battery cells, which may be prismatic cells, often referred to as secondary cells, in particular lithium-ion cells. Each battery pack 104 comprises one or more battery modules, which are connected in series and parallel, to achieve a nominal voltage (e.g. 600-800 V) and a nominal capacity (e.g. 200-300 kWh) for the battery pack 104 to provide the possibility to store energy accessible to the hub 102. Each battery pack may discharge at 0.5-1 C and may charge at up to 0.5 C. The power level of the hub 102 may be between 200 kVA and 275 kVA. In other arrangements, cells may be placed directly into the pack in a so-called “cell-to-pack” arrangement, without the need for separate modules.

Each battery pack 104 may be connected to the hub 102 via a power cable 106 that connects the local DC bus of the battery pack 104 with the common DC bus in the hub 102. Each battery pack 104 may also be connected to the hub 102 via a communication cable 108 connecting a battery management system (BMS) of the battery pack 104 with a programmable logic controller (PLC) of the hub 102. As shown in FIG. 1, the protective panel of battery pack 104c is open and a power cable 106 is connected to the common DC bus of the hub 102 via a connector interface 110 of the hub 102. A communication cable 108 is provided from the battery pack 104c to a communication interface of the hub 102 via the connector interface 110 of the hub 102 in order for the hub 102 to be able to communicate with the battery pack 104c. The power cables 106 may comprise a high-voltage connection between the hub 102 and each battery pack 104, while the communication cables 108 may comprise a low-voltage connection between the hub 102 and each battery pack 104. In some examples, a high-voltage cable may operate in a voltage range of 400V to 1500V, for example between 600V and 800V. In some examples, a low-voltage cable may operate in a voltage range of 12V to 48V. It will be appreciated that, in some embodiments, the power cables 106 may comprise a low-voltage connection between the hub 102 and each battery pack 104.

FIG. 2 is a block diagram of an example embodiment of an energy storage system ESS 100 comprising a hub 102 and a plurality of battery packs 104a-e. In this example up to five battery packs 104 may be included in the ESS 100. The hub 102 comprises an external grid input/output connection 112, a load output 114, an AC/DC converter 116, a control circuitry PLC 118, a common DC bus 120 and a communication interface 122. The external grid input/output connection 112 is connected to an external grid from which external power may be supplied to the hub 102, or power may be output to the external grid to boost the grid depending on the application of the ESS 100. The load output 114 is connected to one or more loads depending on the application, and the external grid and the loads are connected to the AC/DC converter 116 via switches that are controlled by the PLC 118. The lines interconnecting the loads, external grid and AC/DC converter 116 indicate 3-phase wiring.

The hub 102 may be further provided with a thermal management system (TMS) to monitor and control the ESS 100 in case a thermal issue is detected in the battery packs 104 connected to the DC bus 120. The AC/DC converter 116 is connected to the common DC bus 120 which in this example is provided with five quick connects 124 to electrically connect one or more battery packs 104.

Each battery pack 104 comprises at least one module 126, and a BMS configured to communicate with the hub 102 via the communication interface 124 (as indicated by the dotted lines in FIG. 2). The modules 126 are connected via an internal DC bus, a battery connection 128a-e using a quick connect 124 to the common DC bus 120 in the hub 102, and a local TMS is provided to monitor the battery pack in case a thermal issue is detected. The BMS is further configured to control switches interconnecting the local DC bus with the battery connection 128 based on instructions received from the hub 102 via the communication interface 122. The BMS is further configured to provide information related to charge status in the battery pack 104 to the hub 102, receive control signals from the hub 102 to balance the battery pack 104 to a predetermined charge level, and make power accessible to the hub 102 via the common DC bus 120 when instructions to connect the modules 126 to the common DC bus 120 are received.

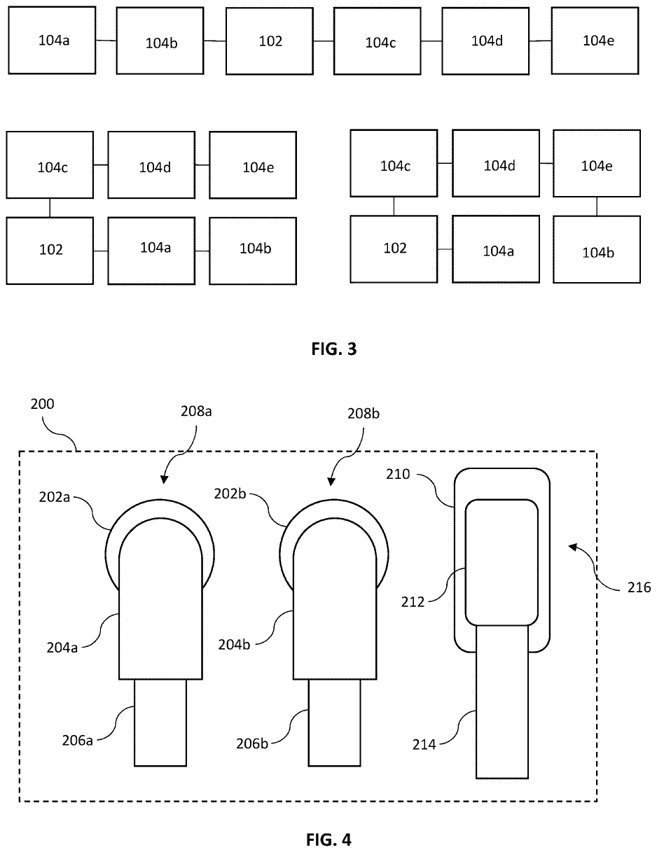

Each unit of the ESS 100 may be transported, for example on a truck, without any special arrangements. However, when the units arrive at the installation site, a qualified technician needs to connect power cables and communication cables and ensure that the ESS 100 is powered up correctly. When assembling the units of an ESS such as the ESS 100, the connections between the hub 102 and the individual battery packs 104 can provide a number of issues. The cabling between units, such as the power cables 106 and the communication cables 108, can be long and heavy and be left lying on the ground. Furthermore, the connector interface 110 of the hub 102 can become crowded with a number of connections in a small area. FIG. 3 illustrates a number of configurations that attempt to address these issues using a daisy chain concept. These implementations enable standardization of cable interfaces and lengths, and more integrated cable routing for hub-to-pack & pack-to-pack connections.

FIG. 4 shows a connector interface 200 for a unit of an ESS 100, such as the connector interface 110 of the hub 102 or a connector interface on a battery pack 104. The connector interface 200 comprises a number of connector ports for associated connectors, which form a corresponding number of connections, as discussed below. The connector 200 interface may be disposed on a unit behind a protective door or panel.

As shown in FIG. 4, the connector interface 200 comprises first connector ports 202a-b, commonly denoted 202. Whilst two first connector ports 202 are shown, it will be appreciated that any suitable number of first connector ports 202 may be present in the connector interface 200, for example, one, three or more. The first connector ports 202a-b are configured to receive corresponding first connectors 204a-b, commonly denoted 204, which are coupled to corresponding cables 206a-b, commonly denoted 206. The cables 206 may be examples of power cables 106. When the first connectors 204a-b are connected to the first connector ports 202a-b, corresponding first connections 208a-b, commonly denoted 208, are made. The first connections 208 comprise both a physical and an electrical connection, as will be appreciated by the skilled person. In one example, the first connections 208 may be high-voltage DC connections. In another example, the ESS 100 may comprise an inverter and output AC power.

The connector interface 200 also comprises a second connector port 210. Whilst a single second connector port 210 is shown, it will be appreciated that any suitable number of second ports 210 may be present in the connector interface 200. The second connector port 210 is configured to receive a corresponding second connector 212, which is coupled to corresponding cable 214. The cable 214 may be an example of a communication cable 108. When the second connector 212 is connected to the second connector port 210, a corresponding second connection 216 is made. The second connection 216 comprises both a physical and an electrical connection, as will be appreciated by the skilled person.

A problem with all current system designs, such as that shown in FIG. 4, is that when operated incorrectly they allow a user to connect or disconnect a high-voltage connection while it is under load, which is a significant safety hazard. If a high-voltage connection is disconnected under load, an electric arc might cause burns on the hands of the person that removes the connector and the connector and port may be damaged. This may also cause an internal overvoltage that could damage other electrical components of the system. One solution to this is the implementation of a high-voltage interlock loop (HVIL). A HVIL is a safety mechanism that acts as a circuit breaker if a high-voltage connection of a system becomes loose, disconnected or damaged during operation. A HVIL could be coupled to a magnetic switch in the door of a unit, to ensure that the circuit is broken as soon as the door is opened and any high-voltage connections cannot be accessed while live. However, this creates a single point of failure, and an alternative solution of running a HVIL through DC connectors of an ESS is costly and may also be unreliable.

To address these issues, an adaptation for a connector interface 200 is required that enables safe interaction with the first connections 208. This is achieved by a cover for the connector interface 200 that enforces a specific sequence of removal or insertion of the connectors 204, 212. In particular, the cover is movable between a first, closed position and a second, open position. In the first position, the cover is held in place by the second connection 216, and the first connections 208 cannot be accessed. Removal of the second connection 216 enables the cover to be moved to the second position, where the first connections 208 can be accessed. In this way, the cover provides a mechanical means to ensure that the second connection 216 must be disconnected before the first connections 208 can be connected or disconnected.

To enable safe interaction with the first connections 208, the connector interface 200 may be configured such that disconnection of the second connector 212 from the second connector port 210 removes power from the at least one first connector port 202. For example, disconnection of the second connection 216 may break a circuit coupled to the first connector ports 208. In one example, a circuit coupled to the first connector ports 202 may be connected to one or more switch or relay that is configured to remove power from the first connector ports 208 when the second connector 212 is removed. In this way, when the second connection 216 is disconnected (e.g. second connector 212 is removed from the second connector port 210), power is removed from the first connector ports 202.

By implementing a mechanical means to ensure that the second connection 216 must be disconnected before the first connections 208 can be connected or disconnected, where removal of the second connector 212 from the second connector port 210 removes power from the at least one first connector port 202, it can be ensured that an operator cannot connect or disconnect a first connection 208 while it is under load. This ensures safe interaction with the first connectors 204 and the first connector ports 202.

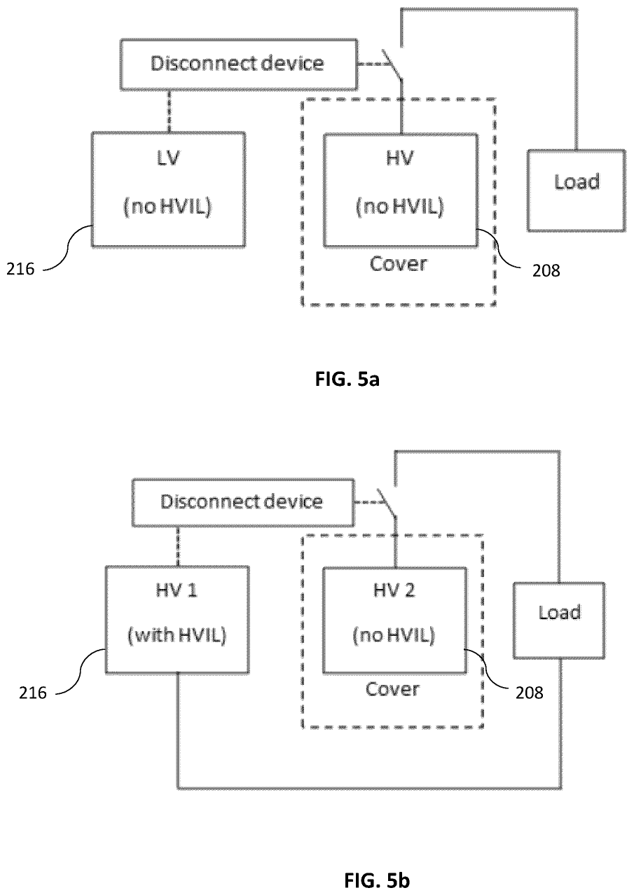

FIGS. 5a and 5b show circuit diagrams for different configurations of an ESS such as the ESS 100.

In one example, shown in FIG. 5a, the first connection 208 is a high-voltage connection and the second connection 216 is a low-voltage connection. The high-voltage connection 208 may be a DC connection. In this implementation, the low-voltage connection 216 must be disconnected before the high-voltage connection 208. The removal of the low-voltage connection 216 will result in the operation of a disconnect device such as a switch, relay, or other device, which causes the power supply to be removed from the high-voltage connection 208. Similarly, the high-voltage connection 208 must be connected before the low-voltage connection 216. Here, the first connection 208 can only be connected while the cover is open. The cover may then have to be closed before the second connection 216 can be made. The disconnect device is the component by which the power to the first connection 208 is removed, for example a relay or switch, and provides the safety action when the second connection 216 is removed. This means the high-voltage connection 208 cannot be accessed and tampered with while it is live. Interaction with the low-voltage connection 216 while it is live is relatively safe.

In another example, shown in FIG. 5b, the first connection 208 is a high-voltage connection without a safety mechanism, whereas the second connection 216 is a high-voltage connection with a safety mechanism such as a HVIL. As the second connection 216 includes the safety mechanism, it is safe to remove without performing a preceding step of removing power from the connection by other means. Both high-voltage connections 208, 216 may be DC connections. In this implementation, the connection with a safety mechanism 216 must be disconnected before the unprotected connection 208, and the unprotected connection 208 must be connected before the connection 216. Interaction with the protected connection 216 while it is live is relatively safe due to the safety mechanism. The first connection 208 is also rendered safe as it cannot be disconnected without first removing the second connection 216 and opening the cover.

As discussed above, it will be appreciated that any suitable number of connector ports 202, 210 may be present in the connector interface 200 to provide a corresponding number of connections 208, 216. For example, whilst one first connection 208 is shown in FIGS. 5a and 5b, the first connections 208 may comprise two or more connections. Similarly, different combinations of high- and low-voltage connections and safety mechanisms may be envisaged.

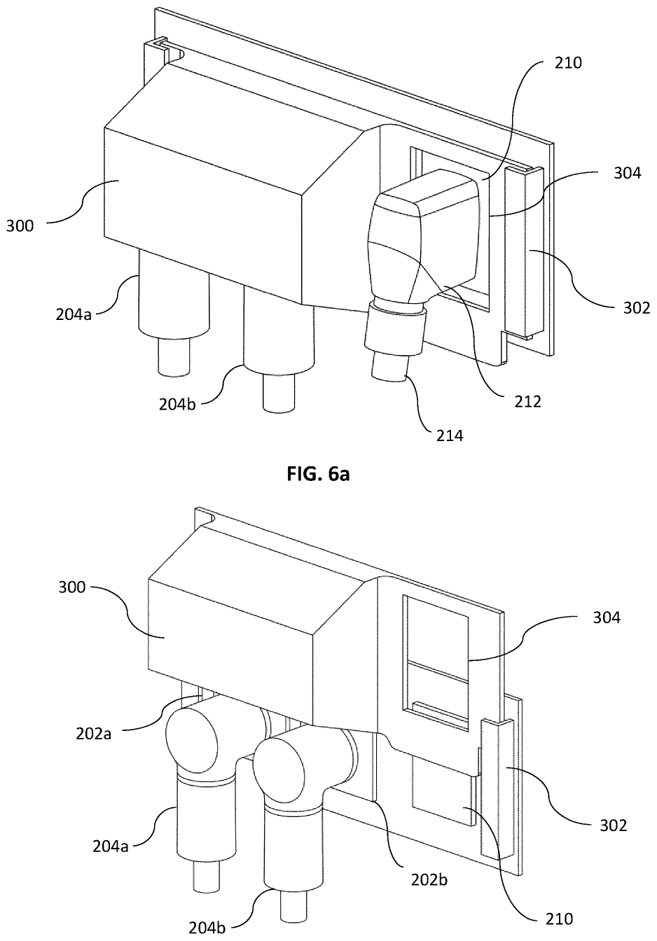

FIGS. 6a and 6b show a connector interface such as the connector interface 200 including a cover 300 according to a first example. FIG. 6a shows the cover 300 in a first, closed position. FIG. 6b shows the cover 300 in a second, open position. The cover 300 is movable between the first position and the second position by means of a sliding rail mechanism 302. In this way, the cover 300 can be mounted close to the surface of the connector interface 200. Alternatively, a hinge mechanism or other type of sliding mechanism could be provided to enable movement of the cover 300 between the first position and the second position.

As shown in FIG. 6a, the cover 300 encloses the first connector ports 202, such that the first connectors 204 are prevented from being put in connection with and/or disconnected from the first connector ports 202. The cover 300 is held in place in the closed position by the second connection 216. In particular, the connection between the second connector port 210 and the second connector 212 releasably retains the cover 300 in the closed position. In particular, the cover 300 has an aperture 304 that enables the second connector 212 to be put in connection with and/or disconnected from the second connector port 210. When the second connector 212 is connected to the second connector port 210 and the cover 300 is in the closed position, the second connector 212 abuts the cover 300 adjacent the aperture 304 when the cover is raised such that the cover 300 cannot be opened.

To access the first connector ports 202, an operator must remove the second connector 212 in order to move the cover 300 to the second, open, position, as shown in FIG. 6b. The cover 300 comprises a handle portion that enables it to be easily moved between the closed and open positions using the sliding rail mechanism 302. In the open position, the cover 300 no longer covers the first connector ports 202, and so the first connectors 204 can be put in connection with and/or disconnected from the first connector ports 202. Furthermore, the handle portion 306 may also function to prevent the second connector 212 being put in connection with the second connector port 210 when the cover 300 is in the open position by blocking access to the second connector port 210.

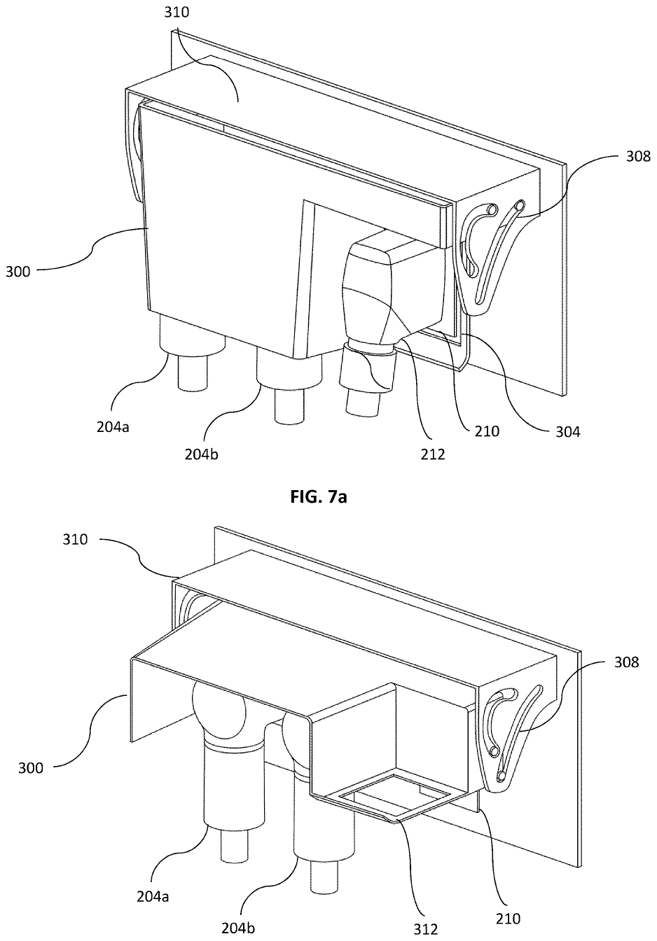

FIGS. 7a and 7b show a connector interface such as the connector interface 200 including a cover 300 according to a second example. FIG. 7a shows the cover 300 in a first, closed position. FIG. 7b shows the cover 300 in a second, open position. The cover 300 is movable between the first position and the second position by means of a sliding mechanism 308. Alternatively, a hinge mechanism could be provided to enable movement of the cover 300 between the first position and the second position. Furthermore, the cover 300 is provided with a rain cover 310 to prevent water entering the connector interface 200 from above.

As shown in FIG. 7a, in the closed position, the cover 300 encloses the first connector ports 202 such that the first connectors 204 are prevented from being put in connection with and/or disconnected from the first connector ports 202. The cover has a recessed portion 312 in the vicinity of the second connector port 202. The cover 300 is prevented from opening by the presence of the second connector 212. In particular, when an operator attempts to open the cover 300, the recessed portion 312 will abut the second connector 212 such that the first connector ports 202 cannot be accessed.

To access the first connector ports 202, an operator must remove the second connector 212 in order to move the cover 300 to the second, open, position, as shown in FIG. 7b. In the open position, the cover 300 no longer covers the first connector ports 202, and so the first connectors 204 can be put in connection with and/or disconnected from the first connector ports 202. When the cover 300 is in the second position, the recessed portion 312 of the cover 300 blocks access to the second connector port 210. This means that, in order to reconnect the second connector 212 to the second connector port 210, the cover 300 must be moved again to the closed position. As such, the first connectors 204 cannot be put in connection with and/or disconnected from the first connector ports 202 while the second connector 212 is connected to the second connector port 210. It will be appreciated that the cover could be recessed, raised or stepped in any suitable way to achieve this functionality.

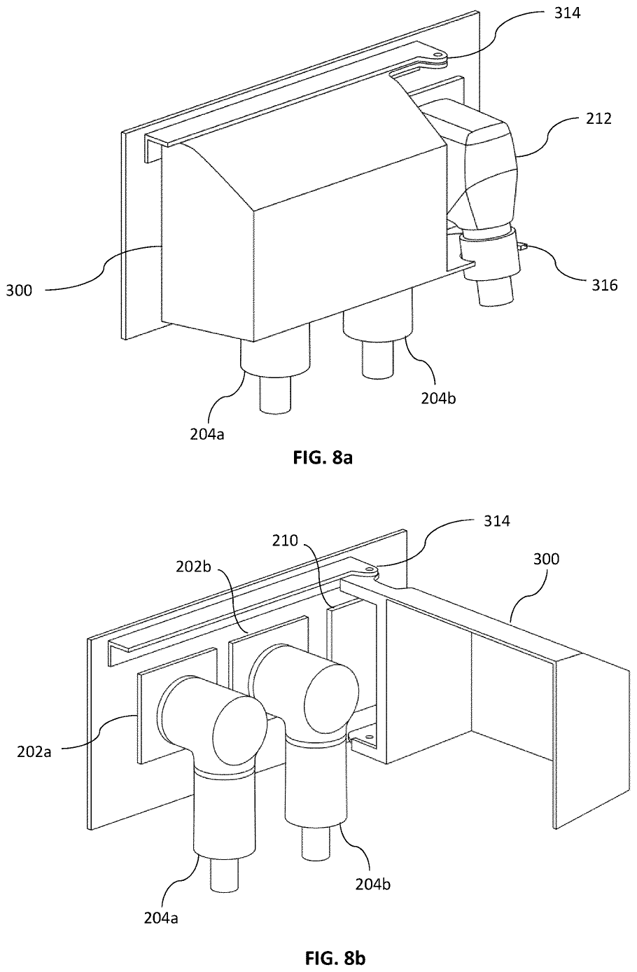

FIGS. 8a and 8b show a connector interface such as the connector interface 200 including a cover 300 according to a third example. FIG. 8a shows the cover 300 in a first, closed position. FIG. 8b shows the cover 300 in a second, open position. The cover 300 is movable between the first position and the second position by means of a hinge mechanism 314. Alternatively, a sliding mechanism could be provided to enable movement of the cover 300 between the first position and the second position.

As shown in FIG. 8a, in the closed position, the cover 300 encloses the first connector ports 202 such that the first connectors 204 are prevented from being put in connection with and/or disconnected from the first connector ports 202. The cover 300 is prevented from opening by the presence of the second connector 212 adjacent the hinge mechanism 314. In particular, when an operator attempts to open the cover 300, it will abut the second connector 210 such that the first connector ports 202 cannot be accessed. In this embodiment, the cover 300 includes a receiving portion 316 configured to receive the second connector 212 and prevent movement of the cover. In other embodiments, the receiving portion 316 may be absent, and abutment between the main part of the cover 300 and the second connector 212 may prevent the cover 300 being opened.

To access the first connector ports 202, an operator must remove the second connector 212 in order to move the cover 300 to the second, open, position, as shown in FIG. 8b. In this position, the cover 300 no longer encloses the first connector ports 202, and so the first connectors 204 can be put in connection with and/or disconnected from the first connector ports 202. Furthermore, in the open position, the cover 300 blocks access to the second connector port 210. Therefore, in order to reconnect the second connector 212 to the second connector port 210, the cover 300 must be moved again to the closed position.

This configuration provides a simple implementation that provides good visual and physical access to the first connector ports 202. As the hinge mechanism 314 is on a lateral side of the cover, it could be implemented with a second connector 212 on either side of the cover 300. The hinge mechanism 314 may comprise a friction hinge. Whilst the hinge mechanism 314 is shown opening the cover 300 horizontally, it will be envisaged that it could be arranged to open the cover 300 vertically with suitable placement of the second connector 212. Whilst the hinge mechanism 314 may be single-pivot hinge mechanism such as a friction hinge, other hinge mechanisms are also possible. For example, a multi-pivot hinge may be used. A multi-pivot hinge may enable to cover 300 to be placed in a particular position when in the open position, which may provide more space around the connector interface 200.

Each of the implementations shown in FIGS. 6 to 8 provides a cover 300 for a connector interface 200 that ensures power is removed from the first connector ports 202 before they can be accessed. In each case, the cover 300 is movable between a first, closed position where it is held in place by the second connection 216 and the first connections 208 cannot be accessed, and a second, open position in which the first connections 208 can be accessed. Removal of the second connection 216 enables the cover 300 to be moved to the second position. In this way, the cover 300 provides a mechanical means to ensure that the second connection 216 must be disconnected before the first connections 208 can be connected or disconnected. As disconnection of the second connector 212 removes power from the at least one first connector port 202, safe interaction with the first connections 208 is enabled. This provides a simple mechanical solution with no electrical failure risk, therefore having high reliability, and in case of failure, no impact on the uptime of the ESS 100. Each cover 300 may provide an intuitive interface for a user, enabling them to comprehend easily how to open the cover 300 and interact with the connector interface 200 in a safe manner.

In each implementation, the cover 300 may be constructed of a material suitable for expected transport and operation conditions. For example, the material may be able to withstand temperatures between −25° C. and 45° C., dusty environments, and be usable by an operator wearing gloves. The cover 300 may be configured such that it does not require any electrical insulation. This may be achieved my making the entire interface touch-proof. The cover 300 may be able to be retained in the closed position during transport to avoid damage. In some examples, the cover 300 may be made of sheet metal (for example steel or aluminium), vacuum-formed plastic, injection moulded plastics, or the like. In some examples, the cover 300 may be made of a transparent material such as acrylic to enable an operator to see the connector interface 200 even when the cover 300 is in the closed position.

Whilst each of the implementations shown in FIGS. 6 to 8 employs a mechanical abutment between the cover 300 and the second connector 212 in order to retain the cover 300 in the closed position, it will be appreciated that other means of interaction, for example a magnetic interaction, could be used to releasably retain the cover 300 in the closed position. Furthermore, the connector interface 200 or the cover 300 may comprise means to retain the cover 300 in the open position to facilitate interaction with the first connections 208. In some implementations, the second connector 212 and the cover 300 may be integrated, such that the removal of the second connector 212 from the connector interface 200 necessarily involves removal of the cover 300.

Modifications and other variants of the described embodiments will come to mind to ones skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure.

Furthermore, although specific terms may be employed herein, they are used in a generic and descriptive sense only and not for purposes of limitation. Therefore, persons skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims (or embodiments), these may possibly advantageously be combined, and the inclusion of different claims (or embodiments) does not imply that a certain combination of features is not feasible and/or advantageous. In addition, singular references do not exclude a plurality. Finally, reference numerals in the claims are provided merely as a clarifying example and should not be construed as limiting the scope of the claims in any way.

1. A connector interface of an energy storage system, the connector interface comprising:
at least one first connector port;
a second connector port; and
a cover movable between a first position and a second position;
wherein:
when in the first position, the cover is configured to prevent at least one first connector being put in connection with and/or disconnected from the at least one first connector port; and
when in the second position, the cover is configured to enable at least one first connector to be put in connection with and/or disconnected from the at least one first connector port; and
wherein:
the cover is configured to be retained in the first position by a second connector when the second connector is connected to the second connector port, and
disconnection of the second connector from the second connector port removes power from the at least one first connector port.

2. The connector interface of claim 1, wherein:
a connection between the second connector and the second connector port is a low-voltage connection; and
a connection between the at least one first connector and the at least one first connector port is a high-voltage connection.

3. The connector interface of claim 1, wherein:
a connection between the second connector and the second connector port is a first high-voltage connection with a safety mechanism, such as a high-voltage interlock loop; and
a connection between the at least one first connector and the at least one first connector port is a second high-voltage connection without a safety mechanism.

4. The connector interface of claim 1, wherein:
the connector interface comprises two first connector ports;
a connection between the second connector and the second connector port is a low-voltage connection; and
a connection between each first connector port and a respective connector is a high-voltage connection.

5. The connector interface of claim 1, wherein the high voltage connection is a DC connection.

6. The connector interface of claim 1, wherein disconnection of the second connector from the second connector port enables movement of the cover between the first and second positions.

7. The connector interface of claim 1, wherein, in the second position, the cover is configured to prevent connection of the second connector to the second connector port.

8. The connector interface of claim 1, wherein the circuit coupled to the at least one first connector is connected to a switch or relay that is configured to remove power from the first connector when the second connector is removed.

9. The connector interface of claim 1, wherein the cover is configured to be retained in the first position by a mechanical abutment or a magnetic interaction with the second connector when the second connector is connected to the second connector port.

10. The connector interface of claim 1, wherein the cover is movable between the first position and the second position by means of a hinge mechanism or a sliding mechanism.

11. The connector interface of claim 1, wherein the cover is configured to be retained in the second position.

12. A battery pack for an energy storage system, the battery pack comprising a connector interface as defined in claim 1.

13. An energy storage system comprising a plurality of battery packs comprising at least one battery pack as defined in claim 12.

14. A cover for a connector interface of an energy storage system, the connector interface comprising at least one first connector port and a second connector port, wherein the cover is movable between a first position and a second position, such that:
when in the first position, the cover is configured to prevent removal of at least one first connector that is connected to the at least one first connector port; and
when in the second position, the cover is configured to enable removal of the at least one first connector from the at least one first connector port;
wherein the cover is configured to be retained in the first position by a second connector when the second connector is connected to the second connector port, and
wherein removal of the second connector from the second connector port breaks a circuit coupled to the at least one first connector port.
